(19) United States
(12) Patent Application Publication
(10) Pub. No.: US 2022/0016719 A1
(43) Pub. Date: Jan. 20, 2022

(54) INTERNAL CLAMPING MEANS FOR CLAMPING A PLURALITY OF WORKPIECES

(71) Applicant: HAINBUCH GMBH SPANNENDE TECHNIK, Marbach (DE)

(72) Inventor: Ioan-Mircea CORBEAN, Marbach (DE)

(21) Appl. No.: 17/371,205

(22) Filed: Jul. 9, 2021

(30) Foreign Application Priority Data
Jul. 16, 2020 (EP) 20186152.3

(51) Int. Cl. B23B 31/40; B23B 31/173

(52) U.S. Cl. CPC B23B 31/4053; B23B 31/4046; B23B 2231/2043; B23B 31/16179; B23B 31/16166

(57) ABSTRACT

An internal clamping arrangement having a base with a clamping mandrel that extends in a main extent direction and has a guide face and at least two clamping sleeves. The clamping sleeves are displaceable in the main extent direction and are pushed onto the guide face of the clamping mandrel from the direction of a distal end of the clamping mandrel. The clamping sleeves have a clamping portion which can be expanded by displacement, and the outside of which has a clamping face for a respective one of the workpieces. The internal clamping arrangement has at least three piston chambers which act between the base and the at least two clamping sleeves and between the clamping sleeves.

### CROSS-REFERENCE TO RELATED APPLICATION

This claims priority from European Application No. 20186152.3, filed Jul. 16, 2020, the disclosure of which is hereby incorporated by reference in its entirety.

### TECHNICAL FIELD AND BACKGROUND

The invention concerns internal means for clamping a plurality of workpieces. An internal clamping means according to the invention serves for the common clamping of several workpieces, wherein different clamping faces are provided for the different workpieces. In the internal clamping means according to the invention, clamping usually takes place for the purpose of subsequent machining of the workpieces, in particular for the purpose of material-removal machining.

In particular, this may be the machining of gearwheels which, after hardening, are clamped together with mutually aligned toothing in order to jointly undergo a final material-removal machining.

EP 0020517 B1 discloses an internal clamping means for clamping a plurality of workpieces. This has a plurality of clamping sleeves which are successively pushed onto a clamping mandrel and can be axially pressed together for the purpose of clamping. In this way, inner conical regions of the clamping sleeves may be pushed onto adjacent outer conical regions of adjacent clamping sleeves and thereby expanded, which again serves for clamping workpieces.

It is known from the unpublished prior art to use several tensioning tubes lying inside one another, in order thereby to be able to selectively move clamping sleeves.

The known internal clamping means are still regarded as disadvantageous. In particular, they do not allow selective clamping of workpieces with a small internal diameter.

### SUMMARY

It is an object of the invention to provide an internal clamping means and a method for clamping and unclamping the internal clamping means, which eliminate or alleviate the described disadvantages.

According to the invention, for this an internal clamping means is proposed for clamping a plurality of workpieces, having a base with a clamping mandrel which is oriented in a main extent direction and on the outside of which a guide face is provided for guiding clamping sleeves. The base of the clamping means in the sense of the invention means the entirety of the components which remain stationary relative to the clamping mandrel in operation during clamping and unclamping of the clamping means.

The internal clamping means has at least two clamping sleeves that are displaceable in the main extent direction. These are pushed onto the guide face of the clamping mandrel from the direction of the distal end of the clamping mandrel. At the distal end of the clamping mandrel, preferably a stop cap belonging to the base is provided, by means of which the clamping sleeves are movably secured on the clamping mandrel. At the proximal end of the clamping mandrel, a spacer sleeve may be pressed on which constitutes a stop for a proximally first clamping sleeve or for a workpiece.

The clamping sleeves each have a clamping portion which can be expanded by means of displacement in the main extent direction, and the outside of which has a clamping face for a respective one of the workpieces. The clamping faces of the various clamping sleeves may, depending on workpieces, be clamping faces of identical size or of sizes which differ from one another in the axial direction and/or radial direction. In the simplest case however, the clamping faces and in particular preferably the entire clamping sleeves are formed identically.

The clamping sleeves are preferably formed integrally. However, multipiece designs are possible in which in particular the clamping portion is separate from a sliding portion of the clamping sleeves. In an integral design, the clamping sleeve is made completely of metal. In a multipiece design, in particular it may be provided that deformable intermediate elements made of an elastomer or similar are provided in the clamping portion, and by means thereof separate metallic segments of the clamping portion are configured so as to be displaceable relative to one another.

According to the invention, it is provided that the internal clamping means has at least three piston chambers which act between the base and the at least two clamping sleeves and between the clamping sleeves. A piston chamber in the sense of the invention is a chamber of variable volume which can be enlarged via fluid pressure, i.e. pressure exerted by gas or a liquid, while at the same time another piston chamber is correspondingly reduced in size. These piston chambers act between the clamping sleeves or between a clamping sleeve and the base. This means that by selective pressurisation by means of gas or liquid, the clamping sleeves can be enlarged and reduced so as to cause a displacement of the clamping sleeves in the axial direction.

Accordingly, by means of these at least three piston chambers, it is possible to selectively force-load the at least two clamping sleeves. In the case of only two clamping sleeves, one of the piston chambers is preferably configured such that on pressurisation, it pushes the two clamping sleeves away from one another. The other two piston chambers act between the base and the first or last clamping sleeve respectively, and on pressurisation are able to pressurise the proximally first clamping sleeve in the distal direction or the proximally last and hence distal clamping sleeve in the proximal direction. By means of at least three piston chambers, the at least two clamping sleeves can thus move selectively and bidirectionally.

Preferably, more than two clamping sleeves are provided which are pushed successively onto the clamping mandrel. The number of piston chambers is preferably one higher than the number of clamping sleeves. In particular, preferably there are three clamping sleeves with four piston chambers, or four clamping sleeves with five piston chambers.

The piston chambers may be provided inside the clamping mandrel and be guided outwardly via clamping pieces which penetrate the guide face of the clamping mandrel so that they are axially coupled to the clamping sleeves.

In contrast however, a design is preferred in which the piston chambers are formed in portions by the clamping sleeves themselves. In this case, the piston chambers are preferably configured as annular piston chambers.

The piston chambers may be delimited on the inside by the guide face of the clamping mandrel so that the piston chambers are effectively provided externally to the clamping mandrel. Such a design with external piston chambers allows a comparatively small structure. In this way, in particular workpieces with a small internal diameter can be easily clamped.

In the case of the first and last piston chambers, these are preferably delimited at the end by a further face of the base and otherwise by the first or last clamping sleeve respectively. In the case of the other clamping sleeves, these are preferably delimited by the two adjacent clamping sleeves and by the guide face. Said components involved in forming the piston chamber, together with sealing means such as O-rings, finally preferably constitute all walls of the respective piston chambers.

The piston chambers are each connected to at least one fluid channel so they can be pressurised and pressure-relieved selectively. In the case of said external piston chambers, the fluid is preferably supplied through fluid channels which penetrate the clamping mandrel and open into the piston chambers through bores in the guide face.

As already explained, the clamping faces may be expanded or radially retracted by axial displacement of the clamping sleeves. For this, it is preferably provided that the clamping sleeves have a conical pressure face on an inside of the clamping portion, and that outer cone faces are provided for radial pressurisation of the pressure face. It is therefore preferably provided that the conical pressure face of the clamping sleeves is provided at the end of the clamping sleeve, preferably the proximal end, so that it is surrounded by an outer cone face extending below this from the proximal end, and can be pushed outward thereby.

Preferably, it is provided that an outer cone face which is stationary with respect to the base, and a respective outer cone face are provided on the clamping sleeves. In particular, preferably the outer cone face that is stationary with respect to the base is provided at the proximal end of the guide face, for force-loading of the pressure face of the proximally first clamping sleeve. The outer cone faces of the clamping sleeves are preferably provided distally offset to the clamping portions of the clamping sleeves.

For guidance on the preferably cylindrical guide face of the clamping mandrel, the clamping sleeves preferably each have a sliding portion with an inner side which is guided slidingly on the guide face of the clamping mandrel. Since it is preferred that the piston chambers are configured as external piston chambers, and it may therefore be necessary to prevent the fluid channels being closed by the sliding inner side, it is preferred that on the inner side, a recess is provided for fluid guidance which is communicatively connected to a piston chamber adjoining the sliding portion in the distal direction.

The described clamping sleeve serves to be able to clamp a plurality of workpieces and to release these again later, wherein this preferably means that the clamping faces of the clamping sleeves are transferred into a clamping state successively, in particular in succession in the distal direction, or transferred into a released state successively, in particular in succession in the proximal direction.

If the clamping sleeves are clamped or unclamped successively, this does not prevent a handling in which all workpieces are pushed on together before clamping begins, and/or in which all clamping sleeves are unclamped before one of the workpieces is removed after machining. Alternatively however, it is also possible during clamping to push one workpiece after the other onto the internal clamping means and then clamp this before the next workpiece is pushed on.

Preferably, clamping takes place in that by means of the pressure in the piston chambers, the clamping sleeves are brought by means of the pressure in the piston chambers into a relative position relative to one another in which the clamping portions are not tensioned or only slightly tensioned. Starting from this, a first workpiece is pushed on or several workpieces are pushed on at the same time.

By subsequently lowering the fluid pressure in a first piston chamber or by raising the fluid pressure in a further and/or last piston chamber, the clamping portion of the proximally first clamping sleeve is tensioned and thereby the first workpiece clamped.

Then, in some cases after subsequently pushing on a second workpiece, by subsequently lowering the fluid pressure in the second piston chamber or raising the fluid pressure in a further or the last piston chamber, the clamping portion of the proximally second and hence next clamping sleeve is tensioned and thereby the second workpiece clamped.

If there are more than two clamping sleeves, this is repeated for each clamping sleeve and hence for each workpiece until all workpieces are clamped.

In particular, the method preferably provides that initially all piston chambers are under pressure and then switched pressureless individually, successively in the direction of the proximal end of the clamping mandrel, so that finally only the last distal piston chamber is still under pressure and the clamping state of all workpieces is maintained.

During unclamping, it is preferably provided that by means of the pressure in the piston chambers, the clamping sleeves are successively displaced such that the tension in their clamping portions is reduced.

This preferably takes place in that the pressure in the piston chamber on the proximal side of the respective clamping sleeve is increased so that the clamping sleeve can be displaced in the direction of the distal end. The piston chamber provided on the opposite distal side of the clamping sleeve has preferably already been switched pressureless. In particular, preferably at the start of unclamping, the last and preferably distal piston chamber is switched pressureless in order to allow release of the workpieces.

### BRIEF DESCRIPTION OF THE DRAWINGS

Further advantages and aspects of the invention arise from the claims and the following description of a preferred exemplary embodiment of the invention, which is explained below with reference to the figures.

FIGS. 1 and 2 show an internal clamping means according to the invention in the installed and partly disassembled states.

FIG. 3 shows the clamping means from FIGS. 1 and 2 in sectional depiction.

FIG. 4 shows a clamping sleeve of the internal clamping means in enlarged sectional depiction.

FIGS. 5 and 6 show the internal clamping means with indicated piston chambers, and a flow diagram for pressurisation of these piston chambers during clamping and unclamping.

FIGS. 7A to 7D show the clamping means in various stages of clamping.

FIGS. 8A to 8E show the clamping means in various stages of unclamping.

### DETAILED DESCRIPTION OF THE EXEMPLARY EMBODIMENTS

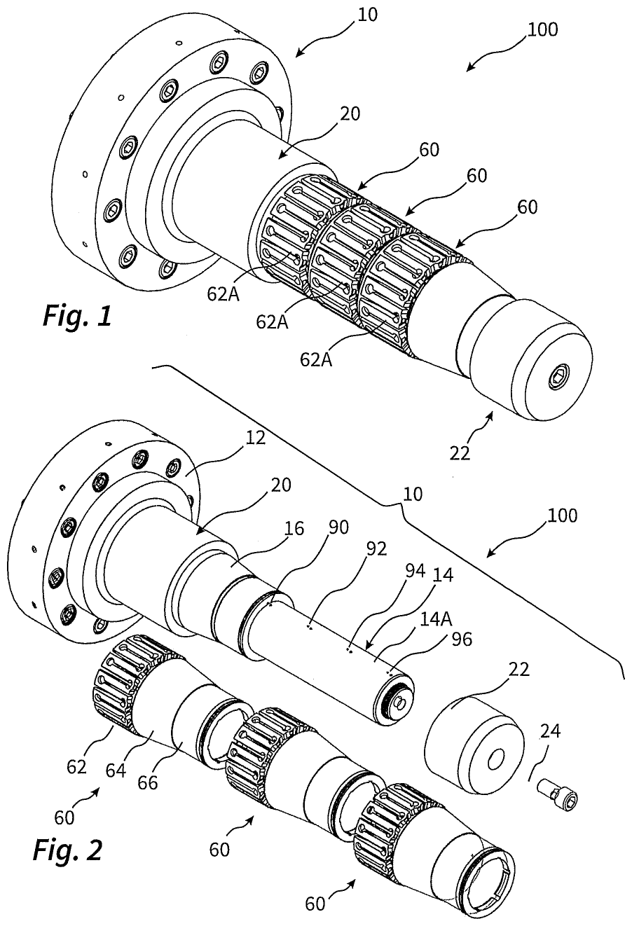

FIGS. 1 and 2 show an internal clamping means 100 according to the invention, wherein FIG. 1 shows this in the installed state and FIG. 2 in the partially disassembled state. The internal clamping means has a base 10 which, by definition, comprises all the parts which remain stationary relative to one another in operation during clamping and unclamping. The base 10 here has an attachment flange 12, from which a clamping mandrel 14 extends. The attachment flange 12 marks the proximal end of the base. The distal end of the base at the distal end of the clamping mandrel 14 is formed by a stop cap 22 which is attached at the end by means of a screw 24. Starting from the attachment flange 12 and in the distal direction, there follows a spacer sleeve 20 which is pushed onto the clamping mandrel. On the distal side of the spacer sleeve 20, the clamping mandrel 14 has an outer cone face 16. The largest part portion of the clamping mandrel 14 is formed by a cylindrical guide face 14A, which is penetrated by fluid channels 90, 91, 92, 93 in a manner to be explained below.

Three clamping sleeves 60 are provided displaceably on the guide face 14A, and each has a sliding portion 66 for sliding displaceability on the guide sleeve 14A, a cone portion with an outer cone face 64, and proximally adjacent thereto a clamping portion 62.

The first clamping sleeves 60 are pushed onto the clamping mandrel 14 in the manner illustrated in FIG. 1, such that the clamping portion 62 of the proximally first clamping sleeve 60 is arranged on the outside of the base-side outer cone face 16. The second and third clamping sleeves 60 are pushed successively onto the clamping mandrel 14 and the guide face 14A in the direction of the distal end, such that their clamping portions 62 are each arranged on the outside of the outer cone face 64 of the respective next clamping sleeve 60 in the direction of the attachment flange 12.

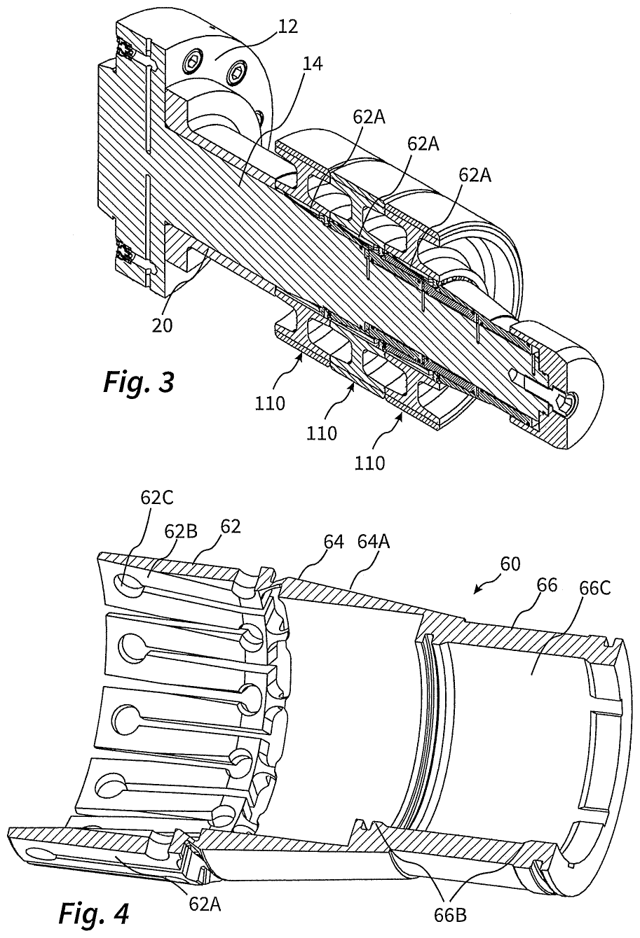

As evident from the sectional depiction in FIG. 3, the clamping means 100 is provided for receiving three workpieces 110. These workpieces 110 and the clamping sleeves 60, and in particular their clamping faces 62A, are matched to one another such that a clamping face 62A is provided for each workpiece 110. The workpieces are gearwheels which, merely for reasons of simplification, are depicted without toothing. The gearwheels are machined jointly by material removal after clamping.

FIG. 4 shows one of the clamping sleeves 60 in detail. The clamping sleeve has three part portions. The left portion in the figure is a clamping portion 62 with the outside clamping face 62A and with an inside pressure face 62B, by means of which the clamping face 62A is pressed outward for the purpose of clamping. The clamping portion 62 is sufficiently deformable thanks to cutouts 62C. A centre portion of the clamping sleeve 60 is formed by an outer cone portion 64 which serves the purpose of force-loading of the pressure face 62B of the adjacent clamping sleeve 60. On the right in FIG. 4, the sliding portion 66 is shown which has an inner sliding face 66B, in which a depression 66C is provided in order to be able to pressurise and pressure-relieve the adjacent piston chamber.

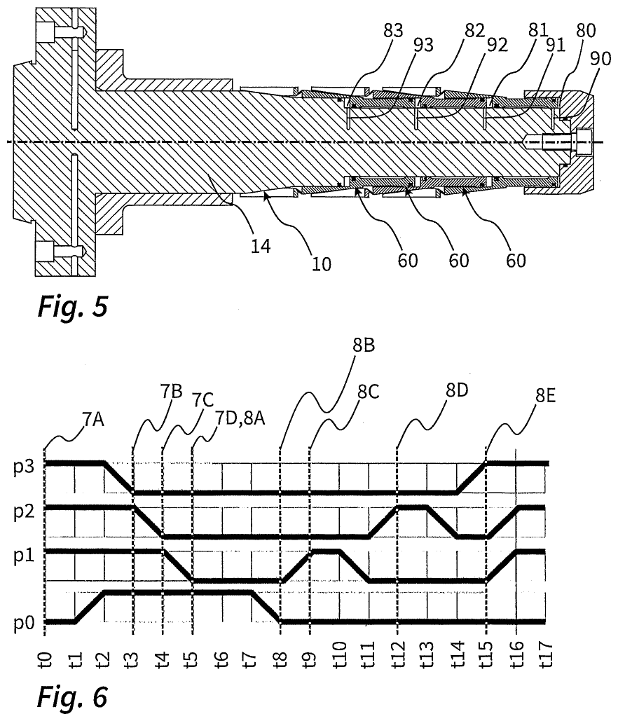

FIG. 5 shows the arrangement of four piston chambers 80, 81, 82, 83 which are configured as an annular chambers and are delimited by the base 10 and the clamping sleeves 60. In the present design with three clamping sleeves 60, four such piston chambers are provided which can be pressurised and pressure-relieved individually via fluid channels 90, 91, 92, 93 (not specified in detail). The proximally first piston chamber 83 is delimited on the inside and in the direction of the proximal end of the internal clamping means by the clamping mandrel 14. On the radial outside and in the direction of the distal end of the inner clamping means, the piston chamber 83 is delimited by the proximally first clamping sleeve 60. The distal piston chamber 80 is also delimited on the inside by the clamping mandrel 14 and its guide face 14A. On the radial outside and in the direction of the distal end, it is delimited by an inside of the stop cap 22. In the proximal direction, the last piston chamber 80 is delimited by the distal last clamping sleeve 60.

The middle two piston chambers 81, 82 are delimited on the inside by the guide face 14A of the clamping mandrel 14 and otherwise by a respective two of the clamping sleeves 60.

By pressurisation or pressure-relief of the piston chambers 80, 81, 82, 83, the clamping sleeve 60 can be force-loaded in the proximal direction, i.e. to the left in relation to FIG. 5, or in the distal direction, i.e. to the right in relation to FIG. 5.

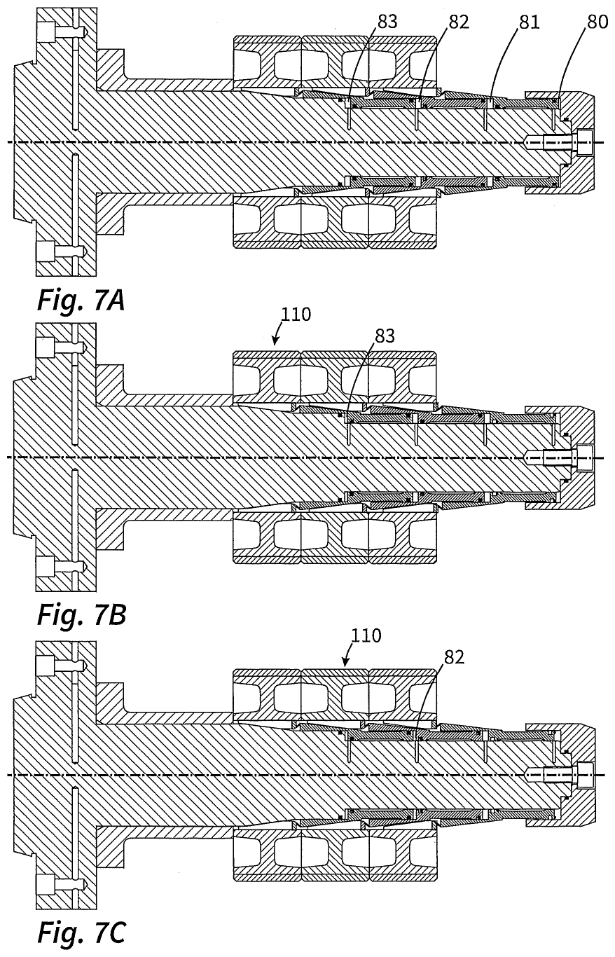

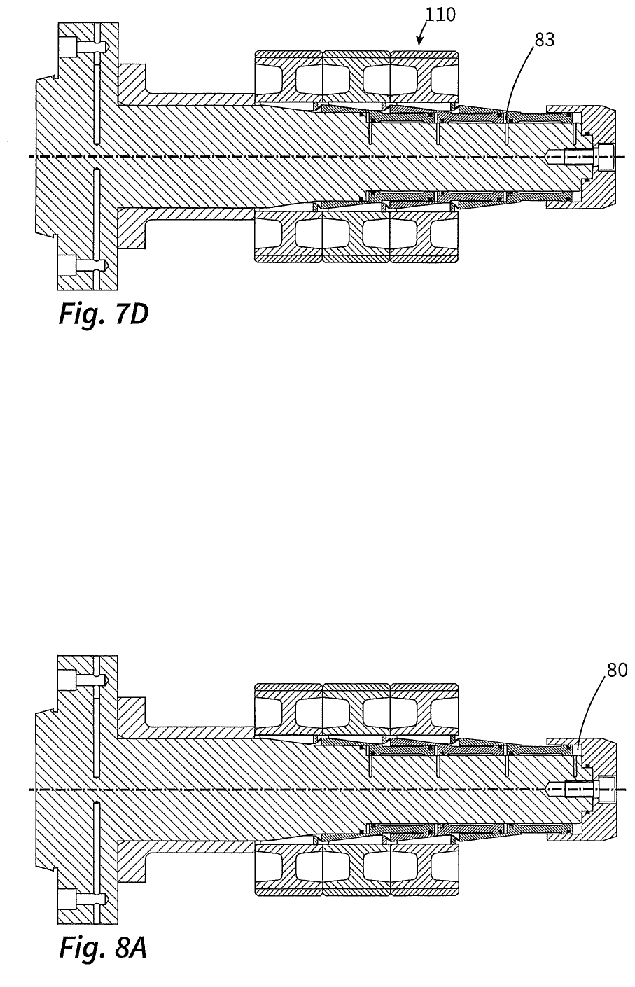

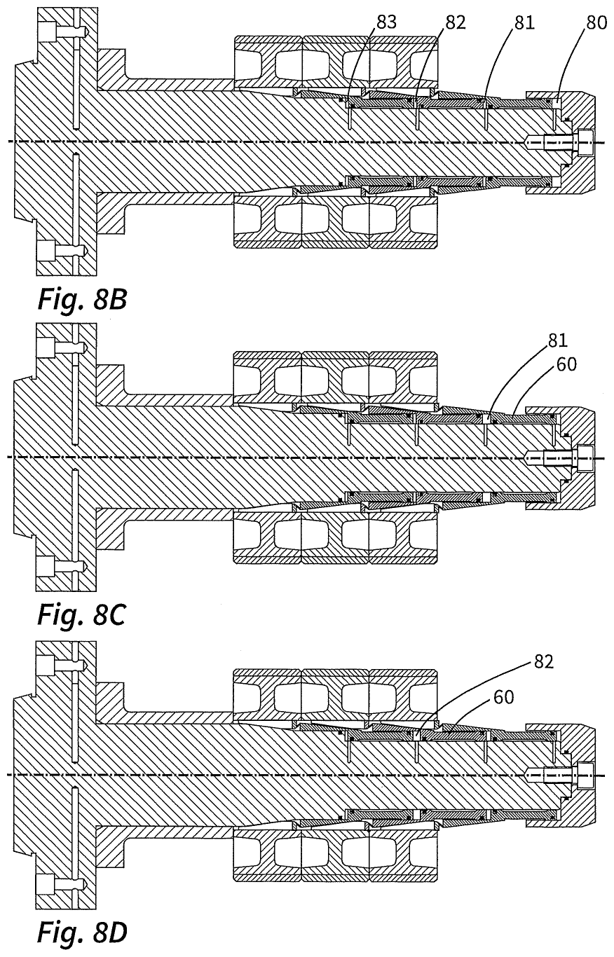

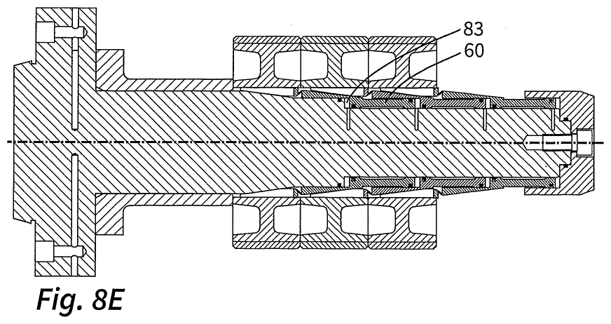

The processes of clamping and unclamping are illustrated with reference to FIG. 6 and the associated FIGS. 7A to 7D and 8A to 8E. In FIG. 6, the various stages of clamping and unclamping are indicated by dotted lines, and their reference signs correspond to the figure numbering of the associated figure.

FIG. 7A shows the state of the clamping means at time T0. At this time, the piston chambers 81, 82, 83 are pressurised by air pressure or fluid pressure, while the distal piston chamber 80 is not yet pressurised.

Starting from here, as illustrated in FIG. 6, at time t1 the distal piston chamber 80 is also pressurised, so that from time t2 it is pressurised like the other piston chambers 81, 82, 83. This in itself does not yet lead to a shift of the clamping sleeves 60 or to clamping, since no positive pressure effective in the direction of the proximal end yet exists in any of the piston chambers.

Only when pressurisation ceases in piston chamber 83 at time t2 does the pressure in the distal piston chamber 80 push all three clamping sleeves 60 in the direction of the proximal end, as illustrated in FIG. 7B. At the proximally first clamping sleeve 60, this leads to the clamping portion 62 being pressed outward via its internal pressure face 62B by the outer cone 16, and hence to the desired clamping state being achieved on the left workpiece 110. This first workpiece 110 is now clamped.

Then at times t4 and t5, the pressurisation of the piston chambers 82 and 81 ceases so that successively the second and third clamping sleeves 60 are moved relative to the respective clamping sleeve 60 arranged on their left, and thus pressed outward by the outer cone faces 64 provided on the clamping sleeves positioned on the left. When the state of FIG. 7D is reached, all workpieces 10 are clamped so that the proposed material-removal machining can take place. After machining, the workpieces are unclamped again.

FIG. 8A firstly shows the still clamped state. With reference to the flow diagram in FIG. 6, it is evident that now firstly the pressurisation of the first piston chamber 80 ceases, wherein—as shown in FIG. 8B—initially this does not yet lead to a movement of the clamping sleeves or to complete elimination of the clamping state, since now all piston chambers 80, 81, 82, 83 are switched pressureless.

Only when the pressure chamber 81 is repressurised at the transition to time t9 does the actual unclamping begin. The pressurisation of the piston chamber 81 moves the proximally last clamping sleeve 60 in the direction of the distal end, i.e. to the right. This releases the clamping state in the clamping portion 62 of this clamping sleeve. Then, as evident in FIG. 6, at the transition from time t10 to t11, the pressurisation of the piston chamber 81 ceases again, but because of the fact that now all piston chambers 80, 81, 82, 83 are pressureless again, this does not lead to a displacement of the clamping sleeves 60.

Only when the further pressure chambers 82 and 83 are briefly pressurised successively at times t12 and t15, in accordance with FIGS. 8D and 8E, are the two further clamping sleeves 60 successively displaced in the direction of the distal end, so that the clamping state is also released for the other two workpieces.

When the state of FIG. 8E has been reached, all workpieces can be jointly removed from the clamping means.

1. An internal clamping means for clamping a plurality of workpieces, with the following features:
a. the internal clamping means has a base with a clamping mandrel which is oriented in a main extent direction and has a guide face, and
b. the internal clamping means has at least two clamping sleeves that are displaceable in the main extent direction and have a clamping portion which is expandable by means of displacement, and the outside of which has a clamping face for a respective one of the workpieces, and
c. the at least two clamping sleeves are pushed onto the guide face of the clamping mandrel from the direction of a distal end of the clamping mandrel, and
d. the internal clamping means has at least three piston chambers which act between the base and the at least two clamping sleeves and between the clamping sleeves.

2. The internal clamping means according to claim 1, with the following further features:
a. the internal clamping means has at least three clamping sleeves which are displaceable in the main extent direction, and
b. the internal clamping means has at least four piston chambers which act between the base and the at least two clamping sleeves and between the clamping sleeves.

3. The internal clamping means according to claim 1, with the following further features:
a. the piston chambers are formed in portions by the clamping sleeves themselves.

4. The internal clamping means according to claim 3, with at least one of the following further features:
a. at least one piston chamber is peripherally delimited by the guide face of the clamping mandrel and by the two clamping sleeves, and/or
b. the first and/or the last piston chamber is peripherally delimited by the base and by the proximally first or proximally last clamping sleeve respectively.

5. The internal clamping means according to claim 3, with the following further feature:
a. fluid channels are provided which penetrate the clamping mandrel and open into the piston chambers through bores in the guide face.

6. The internal clamping means according to claim 1, with the following further features:
a. the clamping sleeves have a conical pressure face on an inside of the clamping portion, and
b. outer cone faces are provided for radial pressurisation of the pressure face.

7. The internal clamping means according to claim 6, with the following further feature:
a. an outer cone face which is provided stationary with respect to the base, and outer cone faces are provided on the clamping sleeves.

8. The internal clamping means according to claim 1, with the following further feature:
a. the clamping sleeves each have a sliding portion with an inner side which is guided slidingly on the guide face of the clamping mandrel.

9. The internal clamping means according to claim 1, with the following further feature:
a. the clamping sleeves are each formed in one piece.

10. The internal clamping means according to claim 1, with the following further feature:
a. the clamping sleeves are formed identically.

11. The internal clamping means according to claim 1, with at least one of the following further features:
a. the guide face is formed cylindrically, and/or
b. a stop cap is provided at the distal end of the clamping mandrel, and/or
c. a spacer sleeve is pushed onto the clamping mandrel and forms a stop for a proximally first clamping sleeve or for a workpiece.

12. A method for clamping a plurality of workpieces with an internal clamping means according to claim 1, including the following steps:
a. the clamping sleeves are brought by the pressure in the piston chambers into a relative position relative to one another in which the clamping portions are not tensioned or are only slightly tensioned, and
b. by lowering the fluid pressure in a first piston chamber or by raising the fluid pressure in a further and/or last piston chamber, the clamping portion of the proximally first clamping sleeve is tensioned and thereby the first workpiece clamped, and
c. by subsequently lowering the fluid pressure in the second piston chamber or raising the fluid pressure in a further or the last piston chamber, the clamping portion of the proximally second clamping sleeve is tensioned and thereby the second workpiece clamped.

13. A method for unclamping a plurality of workpieces with an internal clamping means according to claim 1, including the following steps:
a. with the pressure in the piston chambers, the clamping sleeves are successively displaced such that the tension in their clamping portions is reduced.

14. The internal clamping means according to claim 3, wherein the piston chambers are formed as annular chambers.

15. The internal clamping means according to claim 8, wherein on the inner side, a recess for fluid guidance is provided which is communicatively connected to a piston chamber adjoining the sliding portion in the distal direction.
